(19) United States
(12) Patent Application Publication
(10) Pub. No.: US 2002/0134871 A1
(43) Pub. Date: Sep. 26, 2002

(54) Sinusoidal profile for grinding mill liners

(76) Inventor: Craig J. Anderson, Shoreview, MN (US)

Correspondence Address: MERCHANT & GOULD PC, P.O. BOX 2903, MINNEAPOLIS, MN, 55402-0903, US

(21) Appl. No.: 10/105,044

(22) Filed: Mar. 21, 2002

Related U.S. Application Data
(60) Provisional application No. 60/278,867, filed on Mar. 26, 2001.

(51) Int. Cl. B02C 17/22

(52) U.S. Cl. 241/183

(57) ABSTRACT

A grinding mill liner, characterized by a sinusoidal shape to promote certain types of grinding. In one embodiment, the mill liner shape defines sinusoidal lifters with low face angles whereby impact grinding can be minimized, and attrition grinding can be maximized. In a further embodiment, the inner liner surface shape defines sinusoidal lifters with high face angles whereby impact grinding can be increased, and attrition grinding can be decreased.

### FIELD OF THE INVENTION

This invention broadly relates to grinding mills commonly employed by the mining and mineral processing industries for the reduction of ore size to facilitate the extraction of valuable minerals. More specifically, this invention is directed to an improved profile for the rotatable interior of an ore grinding machine.

### BACKGROUND OF THE INVENTION

In the mining and mineral processing industries, the reduction process typically begins by using dynamite to blast hard rock from a quarry or pit followed by crushing the boulders into smaller rocks and then grinding those rocks in one or two additional steps so that the desired minerals can be extracted and concentrated.

Grinding mills are large, cylindrically shaped metallic chambers that rotate about a horizontal axis. Large rocks are continuously fed into one end of the mill while smaller rocks are discharged from the other end through grates that are designed to allow passage of only the desired size fraction. Because the shell of the mill must be protected from the violent and abrasive tumbling action taking place inside, it is lined with replaceable, wear resistant parts called liners. These liners are individually attached in horizontal rows to the inside of the mill shell by using through-bolts and fasteners on the outside of the shell. These liners are typically metallic or rubber in composition and serve the additional role of lifting the charge material fed into the mill as the mill rotates. Thus, the liners are sometimes also called lifters. The lifting action causes the rocks to tumble against each other and the lifters breaking them into smaller pieces. This action is not unlike the tumbling of garments in a common household clothes dryer.

Autogenous (AG or Auto) grinding is defined by rock breakage that is solely dependent upon rocks impacting with each other or the lifters inside the shell as the mill rotates. Semi-autogenous (SAG) grinding takes place where steel balls are fed into the mill along with the rocks so that breakage can occur when rocks impact with each other, the grinding balls, or the lifters inside the mill. The selection of one method over the other is primarily dependent upon the competence and fracturability of the ore being fed into the mill. Some ores are brittle and easily break into smaller pieces from the tumbling action inside the mill. Others require the addition of grinding media like steel balls to aid in the breakage process. In both cases, some replaceable lifter device is necessary to lift the material charged into the mill as the mill rotates to cause the tumbling action that causes the breakage to take place.

The most recent generation of primary-grinding mills have grown to be 40 feet (12 m.) in diameter and 20 feet (6 m.) in length with up to 6-inch (15 cm) diameter steel balls being utilized in the SAG mode. Many of the older primary mills are less than half this size but still in use. Secondary mills, employed to further reduce the particle size, might use smaller steel balls (ball mills) or long steel rods (rod mills) to tumble against the ore inside.

The primary purpose for the mill lifter is to protect the shell from damage. Two other important objectives must also be achieved. First, the mill lifter must have a shape that effectively promotes efficient grinding of the ore. Second, the mill lifter must be capable of surviving in a harsh environment. Alloy rich steel castings are the most common materials utilized to design a long-lasting lifter able to withstand the violent and abrasive atmosphere inside the mill. It is not uncommon for these lifters to survive the rigors of their job for several months while millions of tons of ore are processed through the mill.

Traditionally, the general shape of the mill liner, or lifter, has been linear with a cross-sectional profile being square, rectangular or most recently, trapezoidal as shown in FIG. 1. Many mills are capable of bi-directional rotation and their liners have a symmetrical lifter profile. The lifter height, shape and spacing are critical elements in promoting efficient grinding and optimum performance from the mill. Too short a lifter fails to lift the charge material high enough, as the mill rotates, to create an effective tumbling action. Too tall a lifter risks throwing the grinding balls all the way across the mill so they impact on and do damage to the liners on the other side without breaking any rocks in the process. Too many lifters, spaced closely together, risks “packing” of the charge material between them like mud in the lugs of a tire. Once packed, the lifters are ineffective at promoting the necessary tumbling action. Spacing the lifters too far apart can also result in an ineffective tumbling action. Among many of the other critical factors affecting mill performance are the speed with which the mill is rotated and the volumetric loading of the mill with grinding media and ore. All of these factors interact with one another to form an immensely complex and multi-parametric equation for mill optimization.

The two predominant mechanisms for particle size reduction in a grinding mill are impact and attrition. Impacts between large rocks cause them to fracture and break into many small pieces. Some of the rocks rotate inside a body of charge material as the grinding mill rotates and those rocks have smaller pieces broken off until they themselves are small. Such action is referred to as attrition grinding.

Therefore, there is a need for a lifter design that will optimize grinding efficiency in the mill while minimizing the damaging impacts caused from charge catapulting across the mill. The design will impart longer life to the lifter and also make it possible to promote or inhibit either of the impact or attrition grinding mechanisms as circumstances warrant for a particular ore type, thus optimizing the performance of the grinding mill.

### SUMMARY OF THE INVENTION

The present invention provides a mathematical formula to characterize an improved shape for a grinding mill liner. By utilizing lifters with a surface defined by a sinusoidal curve, (FIG. 2), it is possible to directly promote or inhibit a particular grinding process within a mill. It has been found that the amplitude of the sinusoidal curve is important to controlling this effect. All lifter surfaces defined by a sinusoid have low face angles (i.e. large angles from vertical) near the lifter peaks and valleys, but high face angles near the lifter surface midpoint. A generally low sinusoidal amplitude promotes attrition grinding because it is least effective in catapulting charge. By increasing the amplitude of the sinusoid however, the face angle at the midpoint of a lifter is increased. A generally high sinusoidal amplitude promotes impact grinding because the lifters tend to catapult material. In one aspect of the invention, a low-amplitude sinusoidal lifter surface of a grinding mill liner can promote attrition grinding. In another aspect, a high-amplitude sinusoidal lifter surface of a grinding mill liner can promote impact grinding. The invention provides a formula for an indefinite number of embodiments, all of which can be customized to promote, via a specific surface shape, various grinding methods in a grinding mill.

In addition, the very smooth transition from peak to valley and the shallow angle in the valley of a sinusoidal shape, as shown in FIG. 3 promote the release of charge material from between the lifts. This minimizes the packing problems sometimes experienced in lifter shapes of a linear design. Also, because of the smooth transitions afforded by this design, it is possible to achieve a greater lifter height (amplitude) without risk of catapulting and thus the lifter itself has a larger cross-sectional area and longer life in the mill before replacement becomes necessary. The larger amplitude and non-linear transition from one lifter to the next also create a longer working surface on the face of the sinusoidal shape than would be possible with a linear shape. The working surface of a sinusoidal shape extends from its peak to its valley where, in the case of a trapezoid, only the one face of that shape does work since the top does little or none at all.

Also, where the sinusoidal shape is utilized in a design such that there are alternating high and low amplitude lifters, the scoop area, defined by the space between the peaks of the two high lifters is maximized. This promotes more work being done by the design since a larger amount of material is trapped between these peaks as the mill rotates. In these designs, the low lifter has an amplitude much smaller than the high lifter. One purpose of the low lifter is to protect the mill shell from damage since the high lifters are doing the majority of the work. Because the low lifter does less work than the high lifter, its amplitude is worn away more slowly than that of the high lifter. The amplitude of the low lifter can be established in actual use and matched to the service life of the high lifter. For example, the low lifter amplitude can be approximately one-fourth that of the high lifter.

### BRIEF DISCUSSION OF THE DRAWINGS

FIG. 1 is a cross-sectional view illustrating the basic shape of a trapezoidal shaped lifter commonly found in prior art grinding mills.

FIG. 2 is a cross-sectional view of a segment of a grinding mill liner assembly illustrating the basic shape of a sinusoidal shaped lifter.

FIG. 3 is a cross-sectional view of a segment of a grinding mill liner assembly illustrating alternating high and low amplitude sinusoidal shaped lifters.

FIG. 4 is a cross-sectional view of a segment of a grinding mill liner assembly illustrating the basic shape of a grinding mill with alternating high and low amplitude modified trapezoidal shaped lifters.

FIG. 5 shows an isometric view of a sinusoidal mill lifter with high amplitude.

FIG. 6 shows an isometric view of a sinusoidal mill lifter with low amplitude.

FIG. 7 shows an isometric view of a grinding mill shell illustrating the basic interior profile of a grinding mill with alternating high and low amplitude sinusoidal shaped lifters.

### DETAILED DESCRIPTION OF THE INVENTION

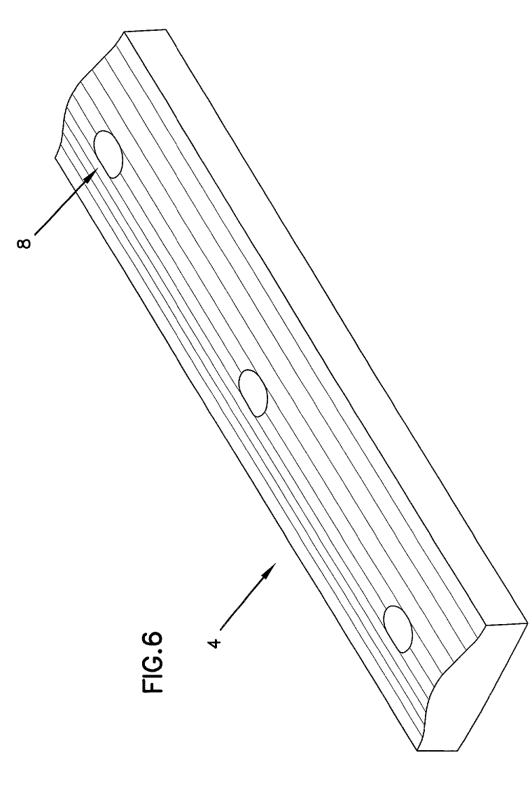

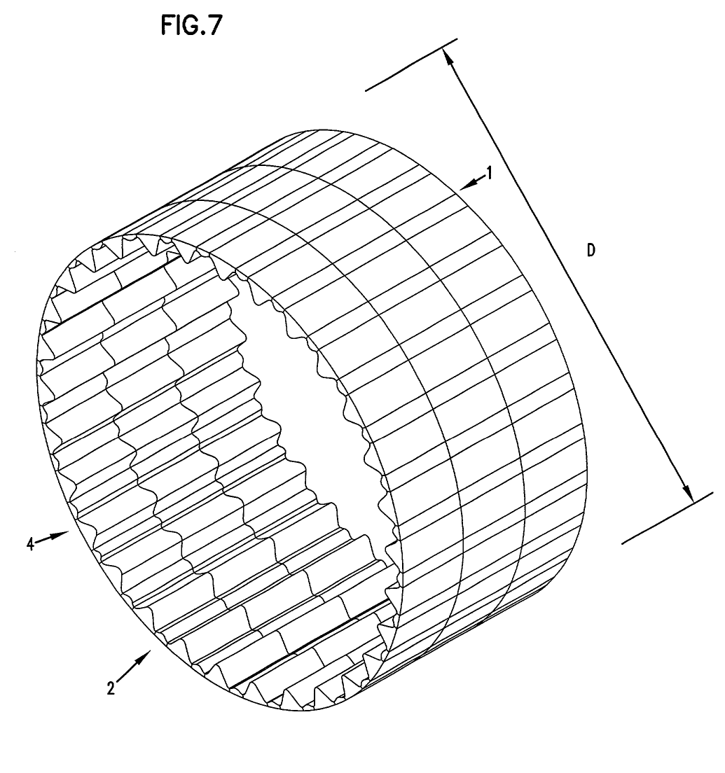

A grinding mill shell 1 is illustrated in FIG. 7. The grinding mill shell 1 includes an inner liner assembly 2. The inner liner assembly 2 typically embodies rows of lifters 4 affixed to the shell 1 using bolt holes 8, shown on FIGS. 5 and 6. The diameter D of the shell 1 is also pictured.

Referring to FIG. 2, in one aspect of the present invention, the surface of the lifter 4 defines a sine wave 6. A non-linear face angle 7 continuously changes on the surface of each lifter 4. The face angle 7 is relatively shallow (i.e. further from vertical) near the top of each lifter 4, and relatively steep near the middle of each lifter 4. This particular configuration has the effect of reducing the distance that the ore can be carried around inside the mill by the lifter 4. Therefore, the distance the charge material is thrown is minimized, and the grinding balls tend to impact with the charge material in the bottom of the shell 1 rather than impact the surface of the liner assembly 2. An additional feature of the sinusoidal shape 6 is that given an appropriate lifter amplitude (i.e. the lifter height), the shallow face angle 7 near the top of each lifter 4 allows ore pieces to roll into the next valley between lifters 4, thus facilitating attrition grinding in the body of the ore.

Conceptually, the sinusoidal shape of the surface of lifter 4 can be expressed in a Cartesian coordinate system by the following equation:

Y=−A·Cos(aL)_{Rad}+A+B

Or, equivalently,

Y=A·[1−Cos(aL)_{Rad}]+B

Y=The height of the lifter

A=The amplitude of the waveform

B=The minimum desired thickness of the lifter 4

a=2π÷C

C=Chord length of the lifter's included angle inside the mill

L=Linear distance along the chord

Thus, when L=0, aL=0 and Cos(aL)=1. This point has coordinates (L=0, Y=B) and defines the left-most point of the lifter's surface. When L=C, then Cos(aL)=1 again. This point has coordinates (L=C, Y=B) defining the right-most point of the lifter's surface. The point where L=C÷2, Cos(aL)=−1 and Y=(2A+B) is the maximum height of the lifter 4.

However, it is more useful to define the sinusoidal shape in polar coordinates with reference to the parameters of a grinding mill into which the lifter 4 is installed. The cross-sectional shape of a grinding mill is a circle of inside diameter “D” (expressed in feet) or an inside radius “r” (expressed in inches). The mill shell 1 is drilled with a number of rows of holes “N” evenly spaced around the circumference of the shell 1 to accommodate the fastening of the lifters 4 to the inside using through-bolts.

Typically, the value for N is approximately 2 times the diameter, D, in feet. For example, a grinding mill of 30-feet inside diameter customarily would have 60 rows of bolt holes. Each row will contain several bolt holes along the longitudinal direction of the mill shell 1 as necessary to fasten all of the lifters to the inside of the shell securely. For instance, a mill shell 1 might be 15 feet (4.6 m) long with 3 cast lifters comprising a row of that length, each of them being 5 feet (1.5 m) in length. Each of those lifters might have 3 bolt holes for fastening. Thus, a grinding mill of 30-feet (9 m) inside diameter and 15 feet (4.6 m) in length might have 9 bolt holes in each row, with 60 rows of bolt holes being spaced around the circumference of the shell for a total of 540 bolt holes. If all of the lifters were of the same size in this example, then each row of lifters would comprise an arc segment of 6-degrees and 60 such rows would comprise the total circle, (60×6 degrees=360 degrees). In this example, the full cycle of one sinusoidal waveform (zero to 2π) would fit within a 6-degree arc segment, φ. If this arc segment is divided into 20 equal segments, αₙ such that α₀=0.00 degrees, α₁=0.30 degrees, α₂=0.60 degrees, . . . , and α₂₀=6.00 degrees, then one can calculate the radial length from the theoretical center of the mill to a point on the surface of the lifter's sinusoidal shape corresponding to each of these smaller segments of the 6 degree arc. Thus a set of polar coordinates (rₙ, αₙ), could be derived from the following equation and utilized to plot the sinusoidal shape of the mill lifter:

rₙ6·D+A·Cos(2π·αₙ÷φ)−A−B

or, equivalently,

rₙ=6·D−A·[1−Cos(2π·αₙ÷φ)]−B

Where, 6·D is equal to the inside radius of the mill in inches.

The point where α₀=0, r₀=(6·D−B) defines the left-most point on the lifter's surface. Similarly, the point where α₂₀=φ, r₂₀=(6·D−B) defines the right most point on the lifter's surface. The point where α₁₀=3 degrees (one half of φ), r₁₀=(6·D−2·A−B), represents the peak or highest point on the lifter's surface.

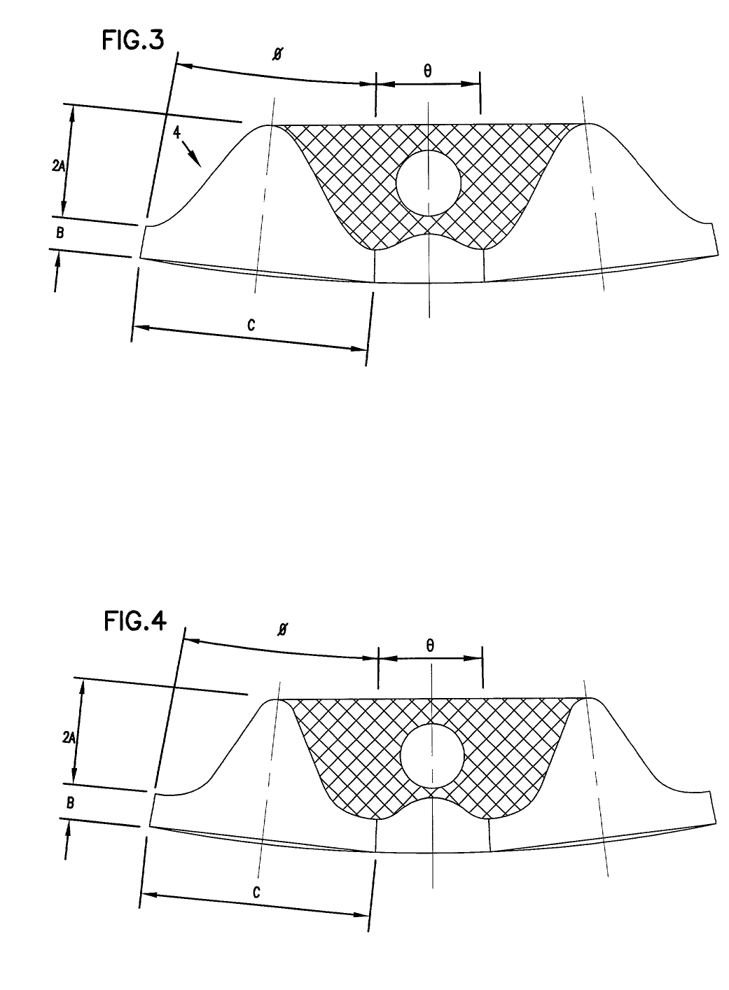

An alternative embodiment of this invention involves combining alternating high and low amplitude sinusoidal shapes with a lifter size adjustment ratio R such that the arc segment of the high amplitude sinusoidal shaped lifter is R times the arc segment of the low amplitude sinusoidal shaped lifter, as shown in FIG. 3. For example, in the grinding mill with an inside diameter of 30 feet (9 m) and a length of 15 feet (4.5 m) discussed above, the shell was assumed to have been drilled with 60 bolts per circle making them equally spaced 6 degrees apart around the circumference. Thus, equally sized lifters would each comprise a 6 degree arc segment and fit exactly 60 of them, edge to edge, within the inside circumference of the mill shell. However, a design could be formulated such that alternating rows of lifters occupied the same total space. For example, the lifters could occupy an 8 degree arc segment and the lifters could occupy a 4 degree arc segment, (FIG. 3). In that example, R=2. The arc segment of the large lifter is twice that of the small lifter and there would still be 60 lifters installed around the inside circumference with 30 large lifters each occupying an arc segment of 4 degrees on either side of the centerline for a bolt hole and 30 small lifters each occupying and arc segment of 2 degrees on either side of the centerline for a bolt hole. Thus, the 6 degree space between bolt holes would be occupied by half of the 8 degree arc segment for a large lifter and half of the 4 degree arc segment for a small lifter. In this embodiment of the device, alternating rows of large lifter with high amplitudes and small lifter with low amplitudes would be employed to maximize the mill's throughput and the lifters' service life. Because the large lifter also has a high amplitude, it will be the device doing most of the work inside the mill, that is, causing an effective tumbling action to occur. The small lifter, with a lower amplitude, will primarily serve to protect the mill shell for the duration of the large lifter's service life. Because the lifter with the highest amplitude, doing most of the work, is also the one with a larger arc segment size, more wear material is available to do the work and that lifter's service life will consequently be extended. Because that lifter has both a high amplitude and larger segment size, it also has a much longer working surface that enhances the grinding mill's throughput. Sinusoidal shapes allow for a higher amplitude than linear shapes since the angle of particle contact near the top of a sinusoidal shaped lifter is too shallow to cause a catapulting of the charge material across the mill to impact with lifters on the other side causing damage to those lifters as well as a waste of the energy that went into causing that motion. Further, alternating high and low lifters allows for a larger scoop area to be formed between the peaks of any two high lifters. This scoop area traps charge material and carries it up as the mill rotates then causing it to tumble back down effecting particle size reduction, the primary purpose for all grinding mills. The amplitude “A” and size ratio “R” establish the aspect ratio to the sinusoidal shape. It is recommended that “A” initially start out at a value of 6 inches and “R” should initially be set to a value of 2 to 1. Then, either or both of these can be adjusted to optimize the impact and attrition grinding performance for a particular application. For manufacturing and assembly purposes, regions on the lifters that are near the bolt holes may depart from the sinusoidal pattern while remaining within the scope of the invention.

### MODIFIED TRAPEZOIDAL SHAPE

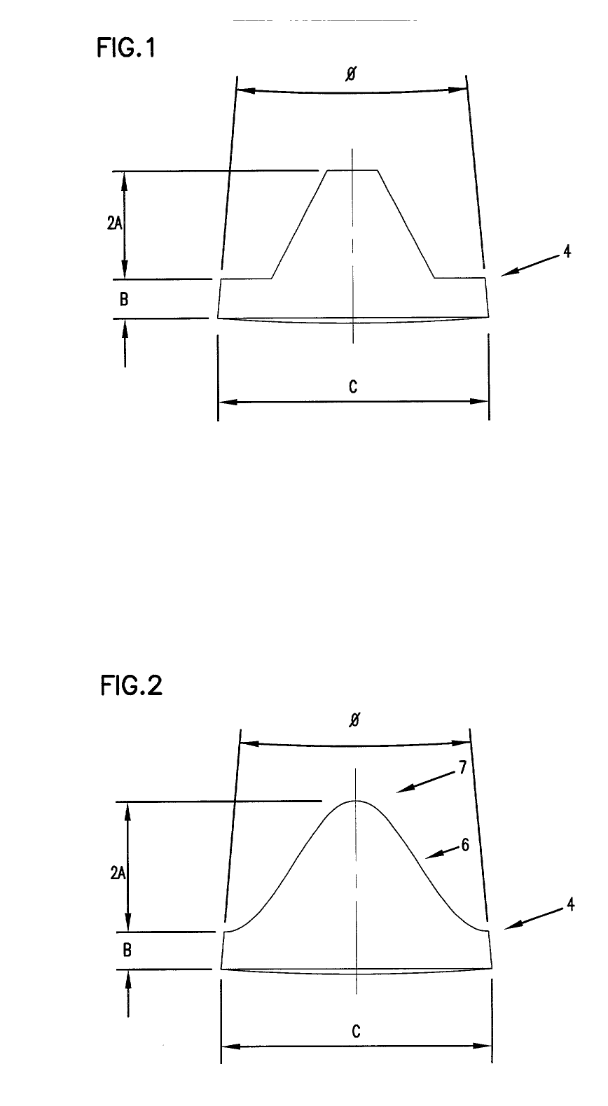

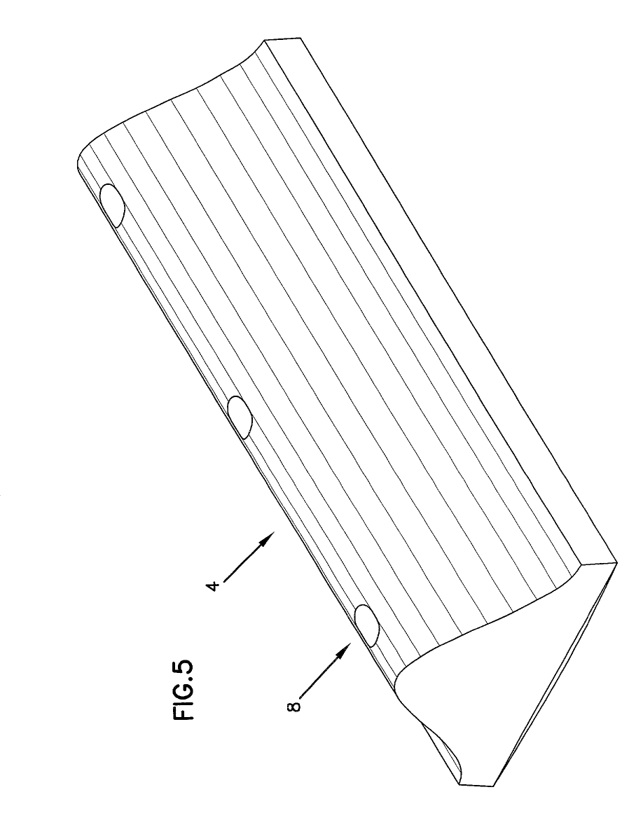

With respect to FIG. 4, a modified trapezoidal lifter design is shown in accordance with the present invention. While the sinusoidal shape optimizes the working surface length of a lifter design, maximizes the effective amplitude and scoop area and allows for an infinite array of adjustments to enhance mill performance, there is also an improvement upon the simple trapezoidal shape which is included here to further illustrate the relationship between lifter height, working surface, face angle, scoop area and the transition between high and low lifters. Technically, the trapezoidal designs commonly found in grinding mills today, (FIG. 1), might more appropriately be called truncated cones. While they have non-parallel sides and a flat top, the base is actually an arc segment defining the junction between the lifter and the mill shell. However, for simplicity in this illustration, we will consider the base of the trapezoid to be represented by the chord “C” of that arc segment. The sides of the trapezoid form an angle, relative to a radius going through the center of the mill's cross-section. This is called the “face angle” for the lifter and typically has had a value between 7 degrees and 35 degrees. At 7 degrees, the trapezoid looks very much like a simple rectangle. As the face angle is increased, the lifter produces a calmer tumbling action in the charge material as the mill rotates, with a lesser propensity for catapulting material across the mill to impact with lifters on the opposite side. However, with an increase in the face angle, the trapezoid must necessarily be reduced in height lest the top become a sharp point forming a triangle and not a trapezoid any longer. The sharp point would be undesirable due to the likelihood that it would break off or quickly wear away, further reducing the height of the lifter in service. While the top of a trapezoidal lifter is subjected to abrasion from charge material as the mill rotates, it contributes little work due to it being oriented tangentially with the motion of the charge material. Thus, the top of the trapezoid is not considered to be a part of the working surface length. Only the sides of the trapezoid do real work on the charge material as the mill rotates, and thus, trapezoids initially have a shorter working surface length than sinusoidal shaped lifters. When the linear discontinuity formed at the junction between the top and side of a trapezoid is worn away in service, the working surface is extended to a point nearer the center of the top and continuing to the discontinuity formed by the junction of the side and the base of the trapezoid. In practice, mill operators call this the “break-in” period during which the mill throughput is actually reduced due to the newly installed trapezoidal lifters having a shorter working surface. Unfortunately, by the time the lifter has “worn-in” and its working surface extended, some of the height of the lifter has been worn away. This reduces its effectiveness with regard to creating the necessary tumbling action and it also reduces its practical service life. Increasing the face angle of a trapezoidal lifter also accelerates the rate at which it wears away, reducing its effective service life, despite the fact that increasing the face angle also reduces undesirable catapulting and may improve mill throughput during the shorter service life. Thus, there are trade-offs between lifter height and face angle for trapezoidal designs. A modification to the simple trapezoid in which the “flat top” is replaced with a curved “dome” facilitates an increase in both the height of the lifter and its initial working surface length without an increase in the undesirable catapulting since, at all points on the surface of the dome, the face angle of the lifter is quite large. Such a modification, (FIG. 4), also adds to the initial scoop area in a high-low lifter configuration simply because the lifter is taller. Utilizing a similar radius to replace the linear discontinuity at the root of the trapezoid (the junction between its side and its base), the initial working surface length can be further extended and a smooth transition to adjacent lifters achieved. Thus, a longer lifter service life and an improvement in mill performance can be expected from these modifications, although not as much as one would achieve by replacing the trapezoidal shape with a sinusoidal lifter. In fact, one might consider replacing the single face of a trapezoid with numerous, short, linear segments each having a different face angle. However, taken to its limit, that process would indeed result in a sinusoidal shape. The sinusoidal shape makes it possible to adjust and optimize all four critical parameters (height, working surface length, face angle and scoop area) to achieve an effective and unique lifter design.

While a detailed description of the invention has been provided above, the present invention is not limited thereto and modifications will be apparent that do not change the spirit of the present invention. Rather, the present invention is defined by the following claims, along with the full scope of equivalents to which the present invention is entitled.

What is claimed is:

1. A grinding mill comprising a shell and inner liner, the surface of said inner liner having a plurality of lifters secured to the inner shell surface, the plurality of lifters defined at least in part by a non-linear surface shape, wherein the non-linear surface shape is defined at least in part by the formula rₙ=6·D−A·[1−Cos(2π·αₙφ)]−B, where rₙ is the length from the theoretical center of the mill to a point on the surface of the lifter's sinusoidal shape, A is an amplitude, 6·D is equal to the inside radius of the mill in inches, B is the minimum desired thickness of the lifter in inches, and φ is the included angle of the lifter, and αₙ is a portion of the included angle φ used for plotting this shape.

2. The grinding mill according to claim 1, wherein the plurality of lifters comprise a pattern of alternating high and low amplitude sinusoidal shapes.

3. The grinding mill according to claim 2, wherein the plurality of lifters contains at least one aperture for fastening the plurality of lifters to the shell.

4. The grinding mill according to claim 3, wherein the high and low amplitude sinusoidal shapes are further defined by a lifter size adjustment ratio R such that the arc segment of the high amplitude sinusoidal shaped lifter is R times the arc segment of the low amplitude sinusoidal shaped lifter, wherein R is a value from 1 to 2.5.

5. The grinding mill according to claim 4, wherein R is 2.

6. The grinding mill according to claim 4, wherein R is 1.

7. The grinding mill according to claim 1, wherein A is at least 6 inches (15 cm.).

8. The grinding mill according to claim 2, wherein the plurality of lifters have thickened edges.

9. The grinding mill according to claim 2, wherein the plurality of lifters are comprised of alloy rich steel castings.

10. The grinding mill according to claim 2, wherein the amplitude of the high amplitude lifter is four times larger than the amplitude of the low amplitude lifter.

11. A lifter, capable of being secured to the inner shell surface of a grinding mill, the lifter being defined at least partially by the formula rₙ=6·D−A·[1−Cos(2π·αₙ÷φ)]−B, where A is an amplitude, 6·D is equal to the inside radius of the mill in inches, B is the minimum desired thickness of the lifter in inches, and φ is the included angle of the lifter, and αₙ is a portion of the included angle φ used for plotting this shape.

12. The lifter of claim 11, wherein the lifter is comprised of an alloy rich steel casting.

13. The lifter of claim 11, wherein the lifter contains at least one aperture for fastening the lifter to the inner shell surface of a grinding mill.

14. The lifter of claim 11, wherein A is at least 6 inches (15 cm.).

15. The lifter of claim 11, wherein the lifter contains thickened edges.

16. A lifter, capable of being secured to the interior shell surface of a grinding mill, the lifter being defined at least partially by the formula Y=A·[1−Cos(aL)_{Rad}]+B, where Y=the height of the lifter, A=the amplitude of the waveform, B=the minimum desired thickness of the lifter, a=2π÷C, C=chord length of the lifter's included angle inside the mill, and L=linear distance along the chord.

17. The lifter of claim 16, wherein the lifter is comprised of an alloy rich steel casting.

18. The lifter of claim 17, wherein the lifter contains a plurality of apertures for fastening the lifter to the inner shell surface of a grinding mill.

19. The lifter of claim 18, wherein A is at least 6 inches (15 cm.).

20. The lifter of claim 19, wherein the lifter contains thickened edges.
